(19) United States
(12) Patent Application Publication
(10) Pub. No.: US 2006/0069665 A1
(43) Pub. Date: Mar. 30, 2006

(54) File access service system, switch apparatus, quota management method and program

(75) Inventors: Satoshi Yamakawa, Tokyo (JP); Takashi Torii, Tokyo (JP); Yoshihiro Kajiki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/233,152

(22) Filed: Sep. 23, 2005

(30) Foreign Application Priority Data
Sep. 24, 2004 (JP) 2004-278001

(51) Int. Cl. G06F 17/30

(52) U.S. Cl. 707/1

(57) ABSTRACT

Disclosed is a file access service system including at least one client, a plurality of file servers each having a function for limiting amount of use of a respective storage resource, and a switch apparatus inserted between the client and the plurality of file servers. The switch apparatus, based upon a set value of amount of use of a storage resource that has been set in the switch apparatus, sets a set value that limits amount of use of each storage resource in a respective one of the file servers. The switch apparatus surveys amount of use of each storage resource periodically in each of the file servers and, based upon the result of the survey controls the set value of the amount of use of each storage resource in each of the file servers.

### FIELD OF THE INVENTION

This invention relates to a switch apparatus inserted logically between a client and file servers. More particularly, the invention relates to an apparatus, system, method and computer program ideal for use in a system that provides a file access service in the form of a single file system in which a plurality of file systems are virtualized as seen by the client.

### BACKGROUND OF THE INVENTION

By way of example, Network Attached Storage (NAS) is used as a network storage system that makes it possible to access file systems from a plurality of hosts using a standard protocol such as NFS (Network File System)/CIFS (Common Internet File System). A network storage system such as NAS provides a file access service that allows a remote client to write and read data to and from storage managed by the remote client per se.

Conventional network storage systems are not equipped with a standard arrangement (mechanism) that allows the system to behave as if it were a single apparatus in which there is cooperation between file servers and NAS devices. For this reason, services provided to a client are closed within an independent apparatus.

A file server comes equipped with a quota system that limits the amount of use (where an allocation of amount of use is referred to as a “quota”) of storage resources with which a device is furnished. The units of management generally are user, group and directory. If writing of data exceeds a preset limit amount on storage use, it is possible for an administrator to exercise control in such a manner that further writing of data cannot be performed. For example, when an allocation routine for allocating data blocks in an operating system receives a request for a new block, a quota check routine is called and the request is checked by the quota check routine. The latter surveys the quota that corresponds to the owner of the particular file. If the amount of use is below the quota, the request is allowed and the amount of allocation is added to the statistics on amount of use. If the amount of use by the file owner has reached the limit, the request is denied, failure is sent back just as if the file system were full and the allocation program does not allocate the requested block.

A user-managed quota is managed based upon a user identifier [the UID of a UNIX (registered trademark) system], and a quota is set on the number of files or blocks owned by the user. Further, a group-managed quota is managed based upon a group identifier [the GID of a UNIX (registered trademark) system], and a quota is set on the number of files or blocks possessed by the group. A directory-managed quota is set with respect to the number of files or blocks under a directory.

Quotas include a hard quota (a hard limit, in which an error is the result when data is written in excess of the quota), and a soft quota (a soft limit, in which if the upper limit of the quota is being approached, the user is so notified).

The user-managed quota structure (record) is provided in correspondence with, e.g., the user identifier and includes information such as the hard and soft limits of blocks, the numbers of blocks and files presently allocated to the user, and number of warnings remaining to be issued to the user until a soft limit is enforced as a hard limit.

Examples of quota management functions are a function that sets the object to be limited in terms of amount of storage used as well as the limit amount, and a function for acquiring information relating to the amount of storage used (rate of use in which the set limit amount serves as the upper limit) by the object set.

Management for setting a quota can employ a management interface with which an already existing NAS device or file server is equipped. By using a management interface, the system administrator may carry out remote log in via a network or local log in. Interfaces include a CLI (Command Line Interface), a GUI (Graphical User Interface), an API (Application Program Interface) loaded in an apparatus individually, and an API loaded as an industrial standard.

Arrangements that integrate NAS devices and file servers and provide a file service of a Single System Image (SSI) in virtual terms are known as file-service virtualization techniques (for example, see the specifications of Japanese Patent Kokai Publications Nos. JP-P2003-203029A and JP-P2004-54607A, referred to as Patent Documents 1 and 2, respectively, below). As shown in FIG. 2, the system described in Patent Document 1 conceals a plurality of file systems from a client 1 via a switch 100 and, by combining this with migration of on-line data, alleviates the load on the server administrator at the time of file server addition or replacement. If the client and servers support the standard protocol (NFS), a plurality of servers will be managed in consolidated fashion and the client will be provided with a file service of a single system image (such as a single NAS) without modification of the existing systems. Alternatively, a system that virtually integrates a plurality of network storage devices and makes it possible to access any storage device as a single network storage device from the client has been proposed as a similar virtualization technique (for example, see the specification of Japanese Patent Kokai Publication No. JP-P2003-345643A, referred to as Patent Document 3 below).

A virtual file system, however, is not equipped with a quota control function for limiting amounts of use of storage resources of a plurality of file servers with respect to a client in integrated fashion, and a quota control function that can be used by individual file servers or NAS devices-cannot be utilized effectively.

Further, in a system equipped with a plurality of file servers and NAS devices that do not possess mutually linked functions, it is desirable to implement a function that cooperates quota control of respective file servers and NAS devices and performs resource management virtually as a single quota.

### SUMMARY OF THE INVENTION

Accordingly, it is an object of the present invention to provide an apparatus, system and method that make it possible to limit use of storage resources of a plurality of file systems in integrated fashion in a network storage system equipped with a plurality of file systems.

Another object of the present invention is to provide an apparatus, system, method and computer program that make it possible to limit use of storage resources of a plurality of file systems in integrated fashion in a network storage system in which a plurality of file systems have been virtualized with respect to a terminal and file access has been made possible in the form of a single file system.

The above and other objects are attained in accordance with a first aspect of the present invention by providing a file access service system comprising: at least one terminal; a plurality of file service providing units each having a function for limiting amount of use of a respective storage resource; and an intermediate unit inserted between the terminal and the plurality of file service providing units; wherein the intermediate unit has means which, on the basis of a set value of amount of use of a storage resource that has been set in the intermediate unit, is for setting a set value that limits amount of use of each storage resource in a respective one of the plurality of file service providing units. In the present invention, the intermediate unit finds amount of use of each storage resource periodically in each of the plurality of file service providing units and, based upon the findings, controls the set value of the amount of use of the storage resource in at least one of the plurality of file service providing units.

Preferably, in the system according to the present invention, the set value of the amount of use of storage resources in each of the plurality of file service providing units is made fixed and, if the overall amount of use of storage resources exceeds the set value that has been set in the intermediate unit, then the set value of amount of use of at least one storage resource of the plurality of file service providing units is changed.

Preferably, in the system according to the present invention, the set value of amount of use of storage resources in each of the plurality of file service providing units is made variable and the set value of amount of use of at least one storage resource of the plurality of file service providing units is changed in accordance with amount of data used.

Preferably, the system further comprises means for exercising control to fix a set value of amount of use of a storage resource of each of the plurality of file service providing units and, in accordance with the amount of use of the storage resource of one file service providing unit, cause data to migrate from this file service providing unit to another file service providing unit.

According to another aspect of the present invention, the above and other objects are attained by providing a file access service system comprising: at least one terminal; a plurality of file systems; and an intermediate unit, which is inserted logically between the terminal and the plurality of file systems, for providing a file access service in which the plurality of file systems are accessed freely as a single file system (referred to as a “virtual file system”) as seen by the terminal; wherein the intermediate unit has control means for managing amount of use of storage resources of the virtual file system.

Preferably, in the system according to the present invention, the control means has means for setting a set value with respect to respective each of the plurality of file systems that construct the virtual file system, wherein the set value limits amount of use of each storage resource of each of the plurality of file systems.

In the system according to the present invention, the storage resources preferably include files and blocks that constitute a file-system resource; and
limit information on number of files and/or limit information on number of blocks, which depends upon at least one among a user, group and directory, is set as a set value that limits amount of use of storage resources of said virtual file system.

In the system according to the present invention, said control means preferably controls to vary at least one set value that limits amount of use of each storage resource of each of said file systems in accordance with amount of use of the storage resource in each of said file systems and the set value that limits amount of use of storage resources of said virtual file system.

In the system according to the present invention, the control means preferably manages a set value that limits amount of use of storage resources of the aggregate of the plurality of file systems that construct the virtual file system, wherein if a total value of amounts of use of storage resources of respective ones of the plurality of file systems that construct the virtual file system exceeds the set value that limits amount of use of storage resources of the virtual file system, then the control means changes at least one of the set values that limit amounts of use of storage resources that have been set in respective ones of the plurality of file systems.

Preferably, in the present invention, the set value that limits amount of use of each storage resource of each of the plurality of file systems that construct the virtual file system is set to a value that satisfies a condition that a total value obtained by adding up each of the set values is equal to a set value that limits amount of use of the storage resources of the virtual file system, or to a set value obtained by adding a prescribed amount of slack to the value that satisfies the above-mentioned condition.

Preferably, in the system according to the present invention, if the amount of use of a storage resource exceeds a prescribed percentage of the set value in at least one file system among the plurality of file systems that construct the virtual file system, control is exercised to cause the data of this one file system to migrate to another file system.

Preferably, in the system according to the present invention, said control means:
monitors amount of use of storage resources with regard to at least one unit of management from among user, group and directory units of management with respect to said file systems that construct said virtual file system; and
based upon result of monitoring amount of use of storage resources of each of said file systems and a set value presently set in relation to said virtual file system, varies and controls at least one set value that limits amount of use of the storage resources of said file systems with regard to at least one unit of management among a user, group and directory.

Preferably, in the system according to the present invention, said control means periodically transmits a query request concerning amount of use of storage resources in any unit of management from among user, group and directory units of management to said file systems that construct said virtual file system;
accepts amount of use of each storage resource as a response to the query request from a respective one of said file systems; and
totals amounts of use of storage resources, which have been acquired from respective one of said file systems, in any unit of management from among user, group and directory units of management, thereby calculating amount of use of storage resources of said virtual file system in any unit of management from among user, group and directory units of management.

Preferably, in the system according to the present invention, if said control means receives notification that amount of use of a storage resource from at least of said file systems has exceeded the set value, then said control means responds to this notification by re-setting the set value relating to amount of use of the storage resource of the at least one file system of said file systems.

Preferably, in the system according to the present invention, if amount of use of a storage resource in each of said file systems has exceeded the set value that has been set in said file system, then said file system exercises control to deny a request to access said file system from said terminal.

Preferably, in the system according to the present invention, the control means performs a periodic survey for acquiring amount of use of each storage resource in each of the plurality of file systems and, if a total value of amounts of use of storage resources in the plurality of file systems acquired by the survey exceeds a set value relating to amount of use of storage resources of the virtual file system, exercises control in such a manner that at least one of the plurality of file systems is caused to shift to a grace period of a predetermined length.

Preferably, in the system according to the present invention, the set value that limits amount of use of each storage resource of each of said file systems that construct said virtual file system is determined based upon a set value that limits amount of use of the storage resources of said virtual file system.

Preferably, in the system according to the present invention, a common set value is set for each of said file systems that construct said virtual file system.

Preferably, in the system according to the present invention, at least one of said file systems prohibits writing of data from said file system to said terminal after the grace period expires.

Preferably, in the system according to the present invention, if amount of use of storage resources of said virtual file system has reached a predetermined prescribed upper-limit value during the grace period, control is exercised so as to terminate the grace period and prohibit writing of data to said file systems that construct said virtual file system.

Preferably, in the system according to the present invention, the set value comprises:
a soft limit that serves as a criterion of control for issuing an alarm and causing a shift to a grace period of a prescribed length if amount of use of a storage resource has exceeded the set value; and
a hard limit that serves as an upper-limit value for prohibiting use of a file system if amount of use of a storage resource has exceeded the set value.

Preferably, in the system according to the present invention, a set value of amount of use of a storage resource that has been set in said intermediate unit is adopted as the soft limit, and the hard limit is set to a value obtained by multiplying the soft limit by number of file systems virtualized.

Preferably, in the system according to the present invention, a set value of amount of use of a storage resource that has been set in said intermediate unit is adopted as the soft limit, and the hard limit is set to a value that is the result of subtracting a prescribed value from a value obtained by multiplying the soft limit by number of file systems virtualized.

Preferably, in the system according to the present invention, a set value of amount of use of a storage resource that has been set in said intermediate unit is adopted as the soft limit, and the hard limit is set to a value that is equal to the soft limit.

Preferably, in the system according to the present invention, the control means resets the set value that limits amount of use of at least one storage resource of the plurality of file systems after the grace period.

Preferably, in the system according to the present invention, if amount of use of a storage resource of said file system has reached a predetermined upper-limit value during the grace period, said file system terminates the grace period and notifies said terminal of a quota error of said file system via said intermediate unit.

Preferably, in the system according to the present invention, if amount of use of a storage resource of said file system has reached a predetermined upper-limit value during the grace period, said control means exercises control for prohibiting writing of data to said file system for a prescribed period of time from expiration of the grace period to execution of the next survey of amount of use of storage resources.

Preferably, in the system according to the present invention, if amount of use of a storage resource in at least one file system among said file systems that construct said virtual file system has exceeded a prescribed percentage of the set value, said control means exercises control for causing an object of a prescribed storage capacity of said one file system to migrate to another file system.

Preferably, in the system according to the present invention, said intermediate unit comprises a switch apparatus inserted logically between said terminal, which constitutes a client, and servers constructing respective ones of said file systems; and
said switch apparatus receives a file-access request from the client, assigns and transfers the file-access request to a suitable server, receives a response to the file-access requests transmitted from said server, and transfers the response to the client that transmitted the file-access request.

Preferably, in the system according to the present invention, said switch apparatus has means for transferring an object-related request, which has been transmitted from the client, to the server that manages the object;
transferring a response to the request from said server to the client that was the source of transmission of the request;
if a source object ID that has been generated by said server is included in the transferred response in order to identify the object, inserting server identification information whereby a server that manages the object corresponding to the source object ID is identified by another server, and rewriting the source object ID to an object ID attended by the information; and
if the object ID attended by the information is included in the transferred request, then the object ID attended by the information is restored to the source object ID.

Preferably, in the system according to the present invention, said switch apparatus has a pseudo file system for managing directory trees of said file systems as a single consolidated directory tree obtained by combining the directory trees, and stores and manages information concerning a first junction of directory trees in the consolidated directory tree.

Preferably, in the system according to the present invention, said servers are NAS (Network Attached Storage) devices, and said switch apparatus performs allocation of said servers utilizing prescribed layer information.

Preferably, in the system according to the present invention, a command for checking a quota in each of said NAS devices is transmitted from said switch apparatus to said NAS devices; and
said switch apparatus acquires information concerning amount of use of storage resources in each of said NAS devices.

According to another aspect of the present invention, the foregoing objects are attained by providing a quota management method in a network file system having at least one terminal, a plurality of file service providing units each having a function for limiting amount of use of a respective storage resource, and an intermediate unit inserted between the terminal and the plurality of file service providing units, the method comprising a step of the causing the intermediate unit to set a set value that limits amount of use of each storage resource in a respective one of the file service providing units based upon a set value of amount of use of a storage resource that has been set in the intermediate unit. In the present invention, the intermediate unit surveys amount of use of each storage resource periodically in each of the plurality of file service providing units and, based upon the result of survey, controls the set values of amounts of use of respective ones of the storage resources in the plurality of file service providing units.

Preferably, in the method of present invention, the set value of the amount of use of a storage resource of the plurality of file service providing units is fixed and, if the overall amount of use of storage resources exceeds the set value that has been set in the intermediate unit, the set value of amount of use of at least one storage resource of the plurality of file service providing units is changed.

Preferably, in the method of present invention, the set value of amount of use of a storage resource of each of the plurality of file service providing units is made variable and the set value of amount of use of at least one storage resource of the plurality of file service providing units is changed in accordance with amount of data used.

Preferably, the method further comprises steps of exercising control to fix a set value of amount of use of a storage resource of each of the plurality of file service providing units and causing data to migrate from one file service providing unit to another file service providing unit in accordance with the amount of use of the storage resource of the file service providing unit.

Preferably, in the method according to the present invention, said intermediate unit provides a file access service in which said file systems are accessed freely as a virtual file system constituting a single file system as seen by said terminal.

Preferably, the method according to the present invention, further comprises the steps of:
said intermediate unit managing a set value that limits amount of use of storage resources of the aggregate of said file systems that construct said virtual file system; and
said control means changing at least one of the set values that limit amounts of use of storage resources that have been set in respective ones of said file systems if a total value of amounts of use of storage resources of respective ones of said file systems that construct said virtual file system exceeds the set value that limits amount of use of storage resources of said virtual file system.

According to another aspect of the present invention, the above and other objects are attained by providing a switch apparatus connected for communication to at least one client and to a plurality of servers each having means for limiting amount of use of a storage resource of a respective file system, the switch apparatus receiving a file-access request from the client, assigning and transferring the file-access request to a suitable server utilizing prescribed layer information, receiving a response to the file-access request transmitted from the server, and transferring the response to the client that was the source of the file-access request, wherein the switch apparatus includes a pseudo file system for managing directory trees of the plurality of file systems as a single consolidated directory tree obtained by combining the directory trees, and provides a file access service in which the file systems of the plurality of servers are accessed freely as a single file system (referred to as a “virtual file system”) as seen by the client; the switch apparatus having control means for managing amount of use of storage resources of the virtual file system.

Preferably, in the switch apparatus according to the present invention, said control means includes means for setting a set value with respect to each of said file systems that construct said virtual file system, wherein the set value limits amount of use of each storage resource of each of said file systems.

Preferably, in the switch apparatus according to the present invention, the storage resources include files and blocks that constitute a file-system resource; and
limit information on number of files and/or limit information on number of blocks, which depends upon at least one among a user, group and directory, is set as a set value that limits amount of use of the storage resource.

Preferably, in the switch apparatus according to the present invention, said control means varies and controls at least one set value that limits amount of use of each storage resource of each of said file systems in accordance with amount of use of the storage resource in each of said file systems and the set value that limits amount of use of storage resources of said virtual file system.

Preferably, in the switch apparatus according to the present invention, said control means:
monitors amount of use of storage resources in said file systems with regard to at least one unit of management from among user, group and directory units of management with respect to said file systems that construct said virtual file system; and
in response to a file-access request in said virtual file system from the client, and based upon result of monitoring and a set value that limits amount of use of a storage resource that has been set in relation to said virtual file system, exercises control of a set value that limits amount of use of a storage resource in each of said file systems that construct said virtual file system.

Preferably, in the switch apparatus according to the present invention, said control means:
periodically transmits a query request concerning amount of use of storage resources in any unit of management from among user, group and directory units of management to said file systems;
acquires amount of use of storage resources sent back as a response to the query request from respective one of said file systems; and
totals amounts of use of storage resources of respective one of said file systems, thereby acquiring information relating to amount of use of storage resources of said virtual file system in any unit of management from among user, group and directory units of management.

Preferably, in the switch apparatus according to the present invention, if said control means receives notification that amount of use of a storage resource from at least of said file systems has exceeded the set value, then said control means responds to this notification by re-setting the set value that limits amount of use of the storage resources of each of said file systems.

Preferably, in the switch apparatus according to the present invention, said control means has means for acquiring amount of use of the plurality of storage resources by performing a periodic survey of amount of use of storage resources in each of said file systems, and exercising control in such a manner that at least one of said file systems is caused to shift to a grace period of a predetermined length if a total value of amounts of use of storage resources of said file systems exceeds a set value that limits amount of use of storage resources of said virtual file system.

Preferably, in the switch apparatus according to the present invention, the set value that limits amount of use of each storage resource of each of said file systems that construct said virtual file system is set based upon a set value that limits amount of use of the storage resources of said virtual file system.

Preferably, in the switch apparatus according to the present invention, a common set value is set for each of said file systems that construct said virtual file system.

Preferably, in the switch apparatus according to the present invention, the set value that limits amount of use of storage resource of each of said file systems that construct said virtual file system is set to a value such that the sum total of the set values will become the set value of said virtual file system or to a value obtained by adding a prescribed amount of slack to said value.

Preferably, in the switch apparatus according to the present invention, said server exercises control for prohibiting writing of data from the client to said file systems after the grace period expires.

Preferably, in the switch apparatus according to the present invention, if amount of use of a storage resource of each of said file systems has reached a predetermined prescribed upper-limit value during the grace period, said server terminates the grace period and prohibits writing of data from the client.

Preferably, in the switch apparatus according to the present invention, the set value comprises:
a soft limit that serves as a criterion for issuing an alarm if amount of use of a storage resource has exceeded the set value; and
a hard limit that serves as an upper-limit value for prohibiting use of a file system if amount of use of a storage resource has exceeded the set value.

Preferably, in the switch apparatus according to the present invention, a set value of amount of use of a storage resource that has been set in said switch apparatus is adopted as the soft limit, and the hard limit is set to a value obtained by multiplying the soft limit by number of file systems virtualized.

Preferably, in the switch apparatus according to the present invention, a set value of amount of use of a storage resource that has been set in said switch apparatus is adopted as the soft limit, and the hard limit is set to a value that is the result of subtracting a prescribed amount from a value obtained by multiplying the soft limit by number of file systems virtualized.

Preferably, in the switch apparatus according to the present invention, a set value of amount of use of a storage resource that has been set in said switch apparatus is adopted as the soft limit, and the hard limit is set to a value that is equal to the soft limit.

Preferably, in the switch apparatus according to the present invention, after the grace period expires, said control means re-sets the set value that limits amount of use of at least one storage resource of said file systems.

Preferably, in the switch apparatus according to the present invention, if amount of use of a storage resource has reached a predetermined upper-limit value during the grace period of said file system, said file system terminates the grace period and notifies the client of a quota error.

Preferably, in the switch apparatus according to the present invention, if amount of use of a storage resource has reached a predetermined upper-limit value during the grace period of the file system, said control means exercises control for prohibiting writing of data to said file system until the next survey of amount of use of storage resources at most even if amount of use of the storage resource has diminished after expiration of the grace period.

Preferably, in the switch apparatus according to the present invention, if amount of use of a storage resource of at least one file system among said file systems that construct said virtual file system has exceeded a prescribed percentage of the set value, said control means causes an object of a prescribed storage capacity of said one file system to migrate to another file system.

Preferably, in the switch apparatus according to the present invention, said switch apparatus stores and manages information concerning a junction of directory trees in the consolidated directory tree.

According to another aspect of the present invention, the above and other objects are attained by providing a computer program run by a computer constituting a switch apparatus connected for communication to at least one client and to a plurality of servers each having means for limiting amount of use of a storage resource of a respective file system, the switch apparatus receiving a file-access request from the client, assigning and transferring the file-access request to a suitable server utilizing prescribed layer information, receiving a response to the file-access request transmitted from the server, and transferring the response to the client that was the source of the file-access request, wherein the switch apparatus includes a pseudo file system for managing directory trees of the plurality of file systems as a single consolidated directory tree obtained by combining the directory trees, and provides a file access service in which the file systems of the plurality of servers are accessed freely as a single file system (referred to as a “virtual file system”) as seen by the client; wherein the program causes the computer to execute processing for managing amount of use of storage resources of the virtual file system.

Preferably, in the program according to the present invention, the computer is caused to execute processing for setting a set value with respect to each of said file systems that construct said virtual file system, wherein the set value limits amount of use of each storage resource of each of said file systems.

Preferably, in the program according to the present invention, the computer is caused to execute processing for varying and controlling at least one set value that limits amount of use of each storage resource of each of said file systems in accordance with amount of use of the storage resource in each of said file systems and the set value that limits amount of use of storage resources of said virtual file system.

Preferably, in the program according to the present invention, the computer is caused to execute processing for periodically transmitting a query request concerning amount of use of storage resources to said file systems, acquiring amount of use of storage resources sent back as a response to the query request from respective one of said file systems; and totaling amounts of use of storage resources of respective one of said file systems, thereby acquiring information relating to amount of use of storage resources of said virtual file system.

Preferably, in the program according to the present invention, the computer is caused to execute processing for exercising control in such a manner that said file systems are caused to shift to a grace period of a predetermined length if a total value of amounts of use of storage resources of said file systems exceeds a set value that limits amount of use of storage resources of said virtual file system.

Preferably, in the program according to the present invention, the computer is caused to execute processing for re-setting the set value that limits amount of use of at least one storage resource of said file systems after the grace period expires.

The meritorious effects of the present invention are summarized as follows.

In accordance with the present invention, quota control among a plurality of file service providing units is made possible and storage management is facilitated and made more efficient.

Further, the burden of storage management and the labor involved in management can be reduced in a system that provides a virtual file system.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram useful in describing the structure and operating principle of an embodiment of the present invention;

FIG. 2 is a block diagram illustrating the structure of an embodiment of the present invention;

FIG. 3 is a block diagram illustrating the structure of a switch according to the embodiment of the present invention;

FIG. 4 is a diagram useful in describing the principle of a pseudo file system according to the embodiment;

FIGS. 5A and 5B are diagrams illustrating an example of the structure of a quota management unit according to this embodiment;

FIGS. 6A to 6C are diagrams for describing first control according to this embodiment;

FIGS. 7A to 7C are diagrams for describing first control according to this embodiment;

FIGS. 8A to 8D are diagrams for describing an access-lock period according to this embodiment;

FIG. 9 is a graph illustrating the relationship between a hard limit and amount of use in first and second control according to this embodiment;

FIG. 10 is a block diagram illustrating the structure of a switch according to another embodiment of the present invention;

FIG. 11 is a diagram for describing the relationship between on-line migration and directory trees according to another embodiment of the present invention; and

FIGS. 12A to 12D are diagrams for describing the relationship between on-line migration and quota management according to another embodiment of the present invention.

### PREFERRED EMBODIMENTS OF THE INVENTION

A preferred mode of practicing the present invention will now be described with reference to the drawings.

In the present invention, an administrator sets a quota in an intermediate unit that virtually consolidates a plurality of file servers or NAS (Network Attached Storage) devices. In accordance with the quota set by the administrator, the intermediate unit sets quotas with respect to the file servers that construct a virtual file system. NAS will be described as an example below, although this does not impose a particular limitation upon the present invention.

Preferably, the intermediate unit periodically carries out inquiry (survey) to the NAS devices with regard to amount of use of storage and performs quota control based upon the result of survey. Several methods are used in control, as set forth below.

(a) In a case where the value of a quota setting of a NAS device is fixed and the overall amount of data used exceeds the set value, the value of the NAS quota setting is changed.

(b) The value of a quota setting of a NAS device is made variable and the value of the NAS quota setting is changed is accordance with the amount of data used.

(c) The quota setting of a NAS device is fixed and data is caused to migrate to another NAS device by on-line migration in accordance with the amount of data used.

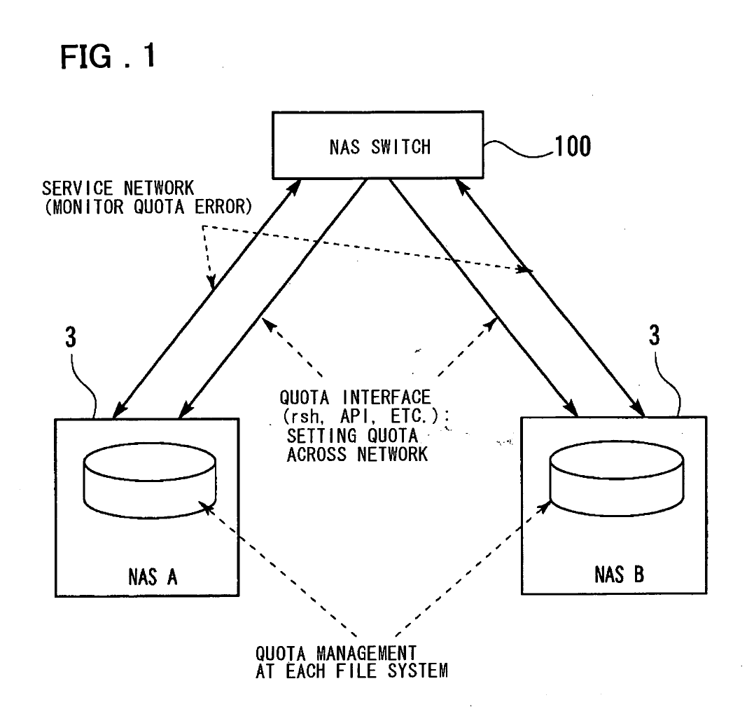

FIG. 1 is a diagram useful in describing a mode of practicing the present invention. As shown in FIG. 1, a NAS switch 100 constitutes an intermediate unit and switch apparatus according to the present invention (as set forth in the claims) and sets the values of quotas of servers 3 (NAS devices in FIG. 1) across a network. Each NAS device 3 performs quota management of its file system. The switch 100 monitors quota errors with regard to the servers (NAS devices) 3.

Quota control can take on various forms. In a case where the set value of the quota of a server (NAS device) 3 is fixed and the overall amount of data used has exceeded the set value, the set value of the quota of the server (NAS device) 3 is changed. In another example, the set value of the quota of a server (NAS device) 3 is made variable and the set value of the quota of the server (NAS device) 3 is changed in accordance with the amount of data used. In a further example, the set value of the quota of a server (NAS device) 3 is fixed and data is caused to migrate to another server (NAS device) by on-line migration in accordance with the amount of data used.

Thus, the present invention is such that in a virtual file system in which a plurality of file systems are virtualized by a switch and a client is provided with a file access service as a single file system, the switch surveys the amount of use of storage resources of the plurality of file systems that constitute the virtual file system, compares the result of the survey of amount of storage resource used with a predetermined control rule and changes, in variable fashion, a set value of a limit on the amount of storage resource used in each file system, thereby making it possible to limit the amount of storage resource used in each file system to a value close to a set value of amount of storage resource used in the virtual file system. The invention will now be described in line with an embodiment thereof.

### EMBODIMENT

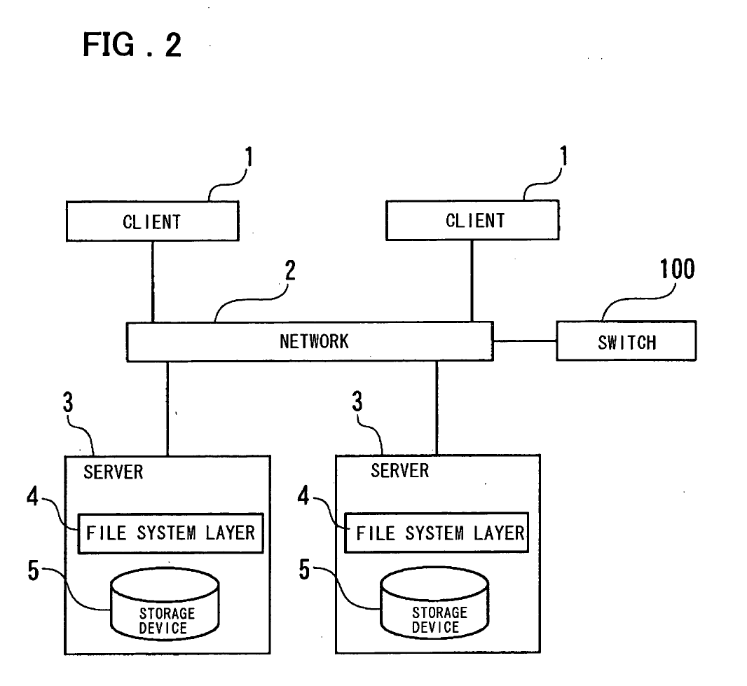

In the embodiment set forth below, the present invention will be described in accordance with an example in which the invention is applied to a virtual file system in which a plurality of file systems are virtualized by a switch and a client is provided with a file access service as a single file system. FIG. 2 is a diagram illustrating the configuration of a network file system which is a client-server remote file system provided with the switch according to the embodiment of this invention. As shown in FIG. 2, the network file system includes at least one client 1, at least one server 3 and the switch 100 connected to a network 2. The server 3 is a file server having a file system layer 4 comprising software for managing the data of files and the like accessed by file access services, and a storage device 5 for storing files and data, and provides each client 1 with the file access service. In the present embodiment, the switch 100 is provided anew with a function for performing quota management for the plurality of servers 3.

Management of correspondence between object IDs and servers in the switch 100 will be described as the basic technique employed by the switch 100 to conceal the existence of the plurality of servers 3 from the clients 1 (for the details, refer to Patent Document 1, etc., mentioned above). The switch 100 receives a file-access request from client 1 and assigns and transfers the file-access request to a suitable server 3. The switch 100 receives a response to the file-access requests transmitted from the server 3 and transfers the response to the client 1 that transmitted the file-access request. In the file-access request, the client 1 designates an object identifying ID (referred to as an “object ID”) of a directory or file that is to be accessed, and accesses the object managed by the server 3. The object ID is generated by the server 3, and the client 1 has a list of accessible objects. The client 1 transmits a request that designates the access path to the object from the list and initially acquires the object ID of the accessible object from the response data from server 3. Further, with regard to an object disposed hierarchically below an object for which the object ID has already been acquired by the client 1, the client 1 transmits the already acquired object ID and a request that designates the name of the object to undergo file access and acquires the object ID from the response to this request.

In the network file system according to the present embodiment, the existence of the server 3 is concealed from the client 1 by the switch 100. A file-access request from the client 1 is transmitted to the switch 100, and the switch 100 receives the file-access request from the client 1 and assigns and transfers (routes) the file-access request to the suitable server 3. The switch 100 receives the response to this file-access request transmitted from the server 3 and transfers (routes) the response to the client 1 that transmitted the file-access request. Since an object ID generated by a server 3 generally is composed of a data string that can be interpreted only by the server 3 that generated it, the switch 100 and client 1 cannot interpret this data. Further, as long as the client 1 receives a response from the server 3 and does not acquire the object ID contained in the response, the client 1 cannot manipulate the object that corresponds to this object ID.

Accordingly, in the present embodiment, the switch 100 inserts server identification information, which is for distinguishing the transmission-source server 3 from another server 3, in an object ID contained in response data transmitted from the transmission-source server 3, re-constructs a packet by the response containing the object ID in which the server identification information has been inserted and transfers the re-constructed packet to the client 1. The client 1 transmits the file-access request, which contains the object ID in which the server identification information has been inserted, to the switch 100. By referring to the server identification information that has been inserted into this object ID, the switch 100 is capable of specifying the destination server to which the file-access request is to be transferred. It should be noted that when the switch 100 transfers the file-access request to the server 3, it converts the object ID having the inserted server identification information to the original object ID generated by the server 3. By providing the switch 100 with this function, distributed processing by a plurality of servers in a network file system is made possible.

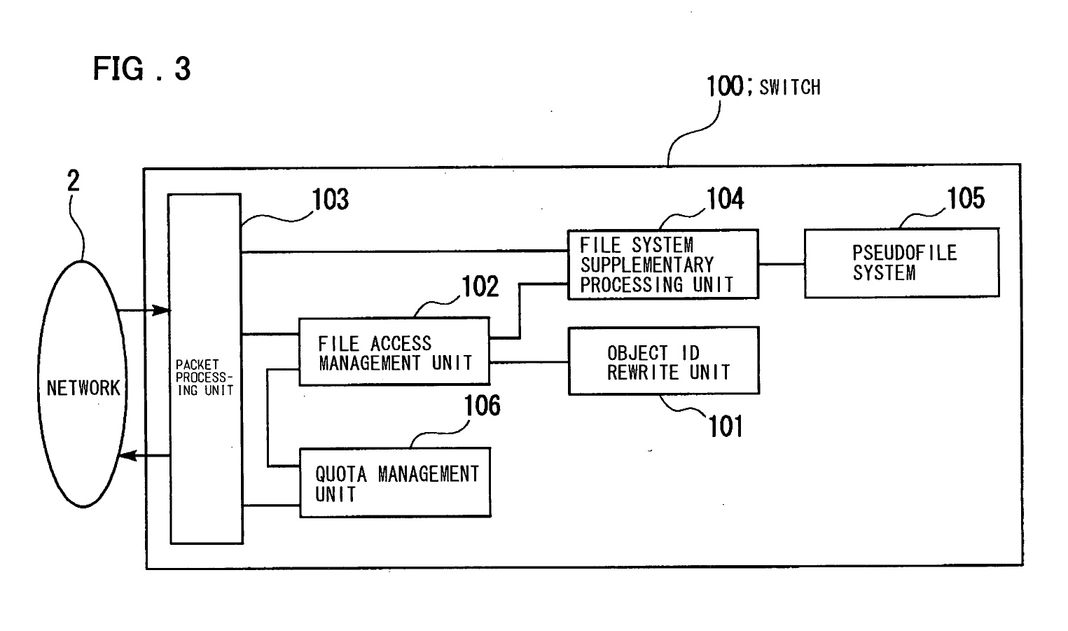

FIG. 3 is a diagram illustrating an example of the structure of the switch 100 according to the present embodiment. As shown in FIG. 3, the switch 100 of the present embodiment includes an object ID rewrite unit 101 for rewriting the above-mentioned object ID; a file access management unit 102; a packet processing unit 103; a file system supplementary processing unit 104; a pseudo file system 105; and a quota management unit 106.

The packet processing unit 103 analyzes a packet received from the client 1 and server 3 via the network 2, outputs data contained in the packet to the file access management unit 102, packetizes the data that has been output from the file access management unit 102 and transmits the packet to the client 1 and server 3 via the network 2.

The file access management unit 102 receives and analyzes the data that has been output from the packet processing unit 103 and decides the routing destination of the packet received by the packet processing unit 103.

In accordance with the packet routing destination decided by the file access management unit 102, the object ID rewrite unit 101 rewrites the object ID contained in the above-mentioned data.

The pseudo file system 105 is a system for combining a plurality of directory trees constituted by respective file systems 4 of the plurality of servers 3 shown in FIG. 2 and managing the combined directory trees as a single consolidated directory tree.

The file system supplementary processing unit 104 executes supplementary processing in a case where a file-access request from the client 1 necessitates file access across a plurality of transmission destinations such as the plurality of servers 3 or plurality of file systems 4.

Based upon the limit value of amount of use of storage resources that has been set in the switch 100, the quota management unit 106 carries out the setting of a set value (quota) for limiting amount of use of storage resources, with respect to the plurality of servers 3.

Further, the quota management unit 106 exercises control to acquire periodic amounts of use of storage resources from the plurality of servers 3, calculate a total value of the amounts of use of the storage resources of the file systems of the plurality of servers 3 and, based upon the result of calculation and the limit value of amount of use of storage resources of the virtual file system, change the set value that limits the amount of use of the storage resources of the servers 3.

Furthermore, the quota management unit 106 monitors quota error of the servers 3 (acquires quota error from the servers 3).

In the present embodiment, it may be so arranged that the processing and functions of the object ID rewrite unit 101, file access management unit 102, packet processing unit 103 and quota management unit 106 in the switch 100 of FIG. 1 are implemented by a program executed by a computer that constitutes the switch 100.

In the present embodiment, quota management per se in each individual file system is performed by each server 3 (user/group, directory, etc.), and the quota management unit 106 of the switch 100 issues instructions, which are for controlling the quota of each file system, based upon the amount of use of storage resources of the virtual file system and the set value thereof.

In addition to a function for assigning file-access request packets and answer packets suitably to the clients 1 or servers 3, the switch 100 has a function for consolidating a plurality of directory trees, which have been formed in the file systems 4 of the plurality of servers 3, into a directory tree of the pseudo file system 105, whereby the arrangement behaves as if only the pseudo file system 105 of the switch 100 is being accessed without the clients 1 being aware of the existence of the individual file systems 4 in the plurality of servers 3.

The pseudo file system 105 freely combines the tree structures of the plurality of directory trees in the file systems 4 publicly disclosed by the servers 3 as being accessible via the network 2 and maps these to one directory tree.

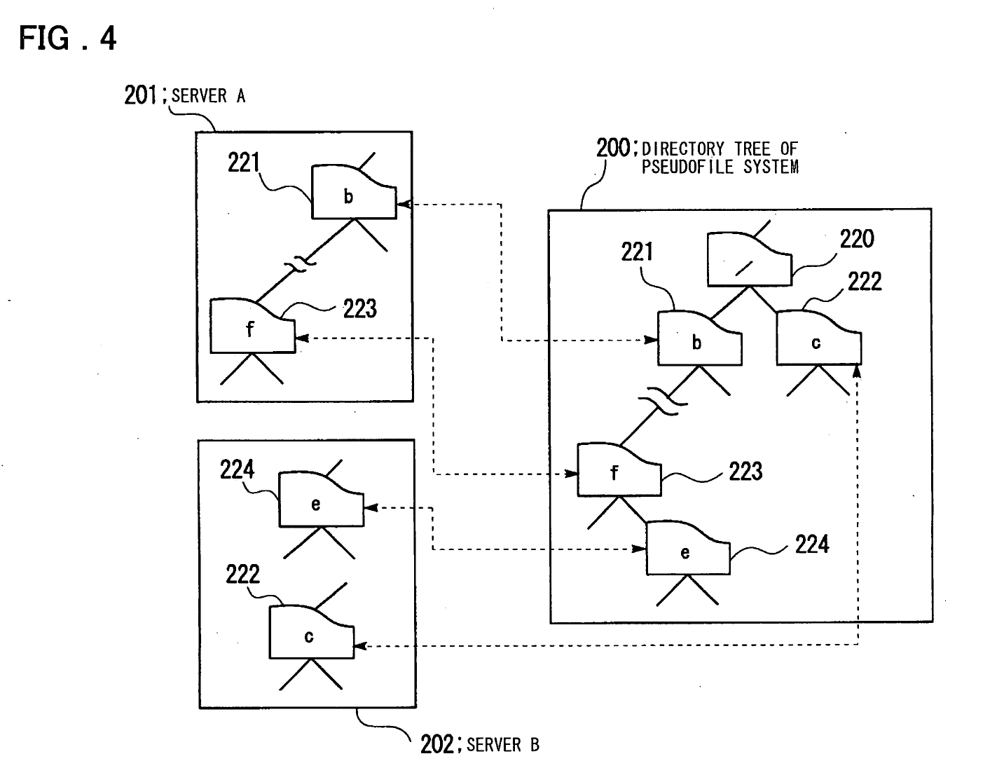

FIG. 4 is a diagram illustrating one example of a directory tree 200 of the pseudo file system 105 shown in FIG. 3. As shown in FIG. 4, the pseudo file system 105 maps the tree structures of directory trees from a directory b (221) disclosed by server A (201) and a directory c (222) disclosed by server B (202), as directory trees from subdirectories of a root directory 220 (/) that has been formed in the pseudo file system 105. The root 220 of the directory tree 200 of the pseudo file system 105 includes pointers to the directories 221 and 222. The pseudo file system 105 registers the tree structure of a directory tree from a directory e (224) disclosed by server B (202) as a directory tree from a subdirectory of a directory f (223) that exists in a layer underneath the directory tree from the directory b (221), thereby generating the directory tree 200 of the pseudo file system 105. In the switch 100 of the present embodiment, the directory names in the directory tree 200 need not necessarily be made the same as the directory names that have been set by the file systems 4 of the servers 3; separate directory names may be set and disclosed to the clients 1.

In the switch 100, the pseudo file system 105 manages only the tree structure of the directory tree 200 of the pseudo file system. The data of the object, attribute information and tree structures other than of the junctions in the file systems 4 are all managed on the side of the servers 3. The switch 100 executes processing for deciding the names only of the tree portions that connect the plurality of file systems 4 and leaves processing regarding the other tree portions (portions other than the junctions) to the servers 3.

In the present embodiment, a limit value on the amount of use of storage resources of the file system in management units of at least any of user, group and director units is set in the switch 100 in relation to the virtual file system (pseudo file system) obtained by consolidating the file systems of the plurality of servers 3.

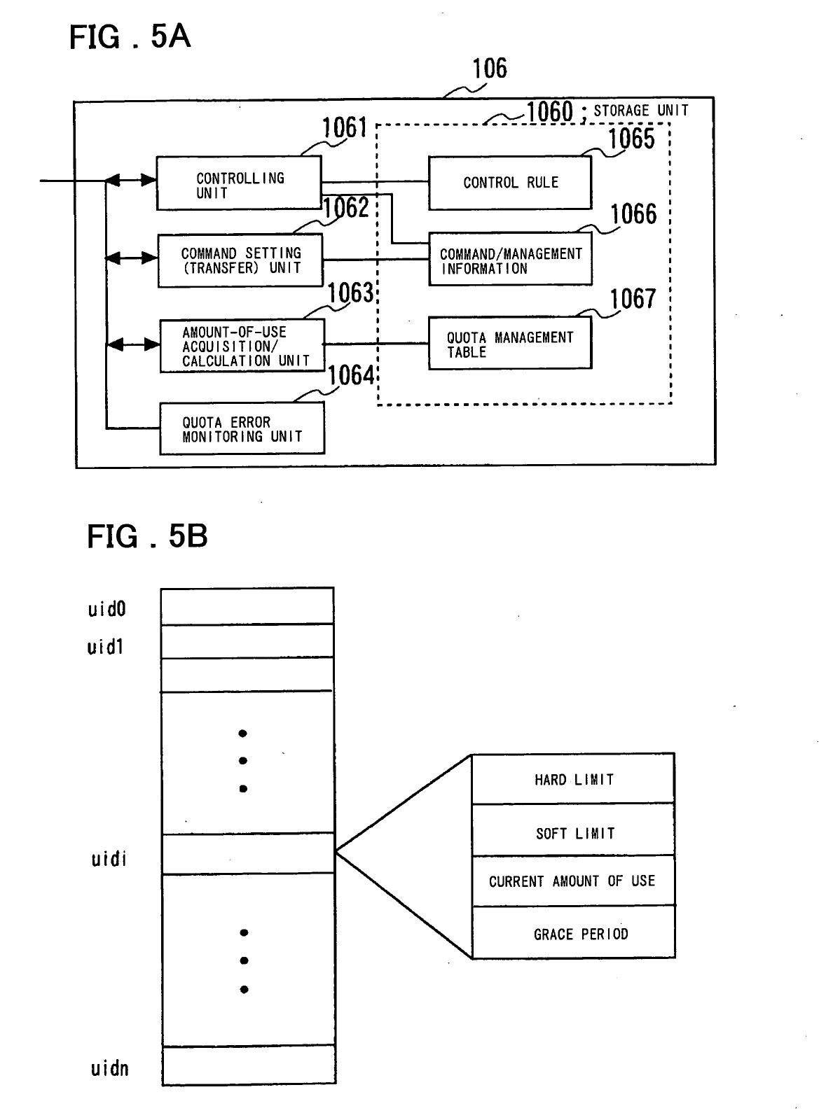

FIG. 5A is a diagram illustrating the structure of the quota management unit 106 according to the present embodiment of the present invention.

Command/management information 1066 in a storage unit 1060 includes a quota setting command, a command for collecting amount of use and polling time information of a periodic survey.

A quota management table 1067 of the virtual file system has a quota management table relating to a system obtained by virtualizing a plurality of file systems into a single system. For example, as shown in FIG. 5B, a hard limit, soft limit, present amount of use and grace-time information of a virtual file system are stored with regard to blocks and files in correspondence with user identifiers uid. Grace period relating to a virtual file system refers to the time it will take to no longer be able to write any data in the event that a quota setting value has been exceeded.

A control rule 1065 stores a rule as to what method should be used to perform quota management of each file system. For example, the control rule 1065 contains information to perform quota management by any of the following, which have been described above: (a) fixing the value of a quota setting, (b) varying the value of a quota setting and (c) fixing the value of a quota setting and causing data to migrate.

A command setting (transfer) unit 1062 controls transfer of:
a command for investigating amount of use of storage resource of a file system; and
a command for setting a quota.
   The command is transferred from the packet processing unit 103 (see FIG. 3) to the server 3.

A controlling unit 1061 has a timer (not shown) and exercises control to transmit the amount-of-use inquiry command to the servers 3 periodically through the command setting (transfer) unit 1062.

An amount-of-use acquisition/calculation unit 1063 acquires information on amount of use transmitted from the server 3 as a response to the amount-of-use inquiry command, totals the acquired amount of use for the plurality of file systems that construct the virtual file system, compares the total with a set value in the quota management table 1067 of the virtual file system and updates the present amount of use in the quota management table 1067 by the total value. It should be noted that the servers 3 constructing the virtual system are managed using a server management table (not shown) in the file access management unit 102 (FIG. 3).

If the total value of present amount of use exceeds the value of the quota setting of the virtual file system, the controlling unit 1061 re-sets the quota with respect to the servers 3 in accordance with the control rule 1065.

A quota error monitoring unit 1064 monitors quota errors from the servers 3. When a quota error is acquired from a server 3, the quota error monitoring unit 1064 performs the necessary control, such as notifying the client 1 and setting a command sent to the server 3, via the controlling unit 1061.

It is assumed that the plurality of servers 3 and switch 100 constructing the network file system of the present embodiment share user information and group information logged in to the servers 3. With regard to the servers 3, the switch 100 has a list of user identification information for file access by an NFS protocol, and has a quota record corresponding to the user identification information, which has the structure shown in FIG. 5B, as the quota management table 1067 of the virtual file system. Similarly, with regard to a group, the switch 100 has a quota record corresponding to group identification information. With regard to a directory, quotas and amount-of-use information are managed by a table with regard to a certain specific directory in correspondence with the consolidated directory tree (200 in FIG. 4) of the pseudo file system 105.

In each server 3, the setting of quotas is performed in each of user, group and directory units locally on a per-server basis.

On the other hand, in a case where a quota is set from the switch 100 to a server 3, log-in to the server 3 is performed remotely and the quota setting is made using the command of the server 3 to which log-in has been performed. In a case where functions and commands differ for the plurality of servers 3, commands for acquiring amount of use, setting quotas and changing quotas are stored beforehand as the command/management information 1066 in the storage unit 1060 of the switch 100 in correspondence with the identification information of each server 3 for every server that constructs the virtual file server. In a case where the plurality of servers 3 have the same functions, file system layers and operating systems, the commands for acquiring amount of use, setting quotas and changing quotas are made to correspond to one type of server.

Information on the duration of the survey of amount of storage used performed periodically by the switch 100 with regard to the servers 3 is set in the command/management information 1066 and is set as time-out information in a timer (not shown) of the controlling unit 1061. The controlling unit 1061 exercises control to transmit the amount-of-use inquiry command to each server 3 when a time-out occurs.

Depending upon the file server, a specific API is provided and not just setting/information acquisition means by remote log-in. Commands are transferred directly from the remote location to perform the setting of quotas. The command setting (transfer) unit 1062 of the switch transfers commands that comply with the APIs.

In the Linux environment, for example, the amount-of-use inquiry is such that list information is acquired by the following two commands:
quotacheck: checks quota status and reflects the result to the quota management file inside the server; and
repquota: writes in and displays a quota management file.

Further, the following is set as a quota setting:
edquota: sets the user name, group name and limit value (the upper limit on data size and number of files).

File servers having the Linux operating system also have a soft limit (=value of the quota setting; a threshold value that assures writing of the minimum amount and issues an alarm if the setting is exceeded), a hard limit (greater than the soft limit; a threshold value at which writing can no longer be performed), and a grace period (time from attainment of the soft limit to time at which writing becomes impossible). The setting of these parameters is carried out. It should be noted that quotas of different management units, such as user and group units, are not consolidated and managed.

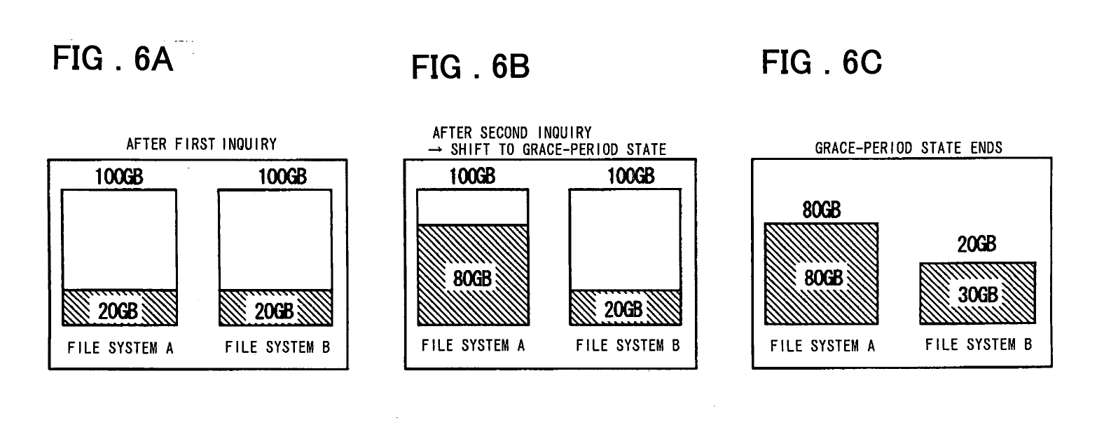

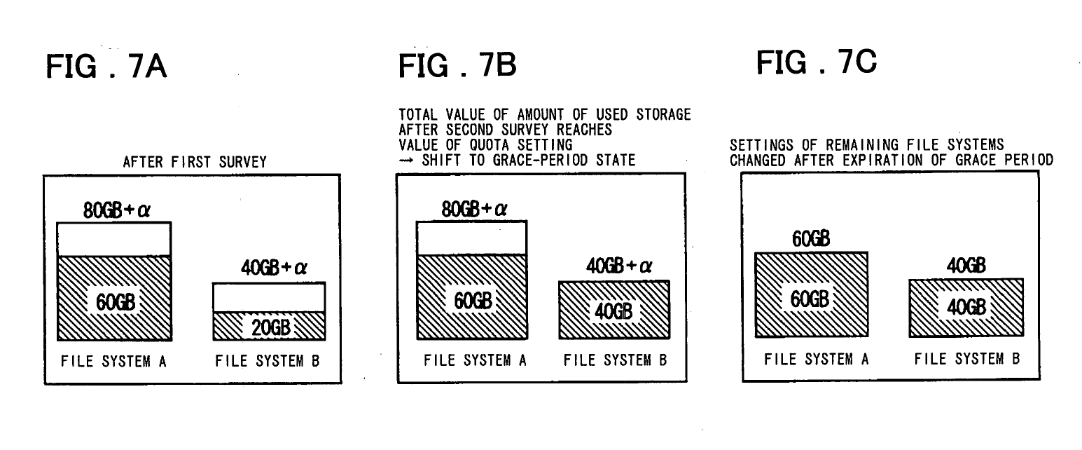

In the present embodiment, settings in the servers by the administrator are as follows in relation to quotas:
designation of unit of quota management [user/group, directory (Qtree)];
threshold value for reporting alarm to administrator (determines at what percentage of the total amount or at what percentage of the amount of each file system the amount of storage resource used must reach to issue an alarm); and
quota control scheme (stored in the control rule 1065 of storage unit 1060; see FIGS. 6 and 7, described later).

The information set in the switch 100 is as follows:
intervals of amount-of-use inquiry; and
log-in user name and password for automatically executing setting of each server by switch 100.

As for the setting of each server, it may be so arranged that a grace period is not provided at the server 3. Instead, the setting may be such that after the hard limit is reached at the server, writing in excess of this quantity is prohibited and a quota error is sent back immediately.

In the virtual file system environment in which the switch 100 of the present embodiment is used, the soft limit of the server 3 is adopted as an upper-limit value that the switch 100 sets with respect to the server 3, and the hard limit of the server 3 is adopted as an upper-limit value which is the soft limit +α (where α represents slack).

In the present embodiment, the grace period of the server 3 is made a period of time that is longer than the duration of the survey of amount of use of storage resources set in the switch 100.

In the present embodiment, it may be so arranged that the status of the amount of use of the storage resources of server 3 acquired periodically by the switch 100 is displayed and output in the form of a list at the client 1 or at an administrator terminal connected locally to the switch 100.

FIGS. 6A to 6C are diagrams for describing quota control according to the embodiment of the invention shown in FIG. 2. The example illustrated in FIGS. 6A to 6C is not limited to a NAS switch (a switch that virtualizes NAS devices) and is applicable to any intermediate unit situated logically between a file server and client. A value equivalent to the quota setting in virtualization is set with regard to all file systems A and B. If the result of an survey of the amount of use of storage resources is that the total value of amounts of use of storage of the file systems has exceeded the value of the quota setting, then a transition is made to the grace-period state and the value of the quota setting is changed with regard to each file system so as to completely prohibit the writing of data after the preset period of time. If the quota upper-limit value of each file system is reached in the grace period, the grace-period state is terminated using a quota-error response (a response from the server) as a key.

In the example shown in FIGS. 6A to 6C, 100 GB is set in the switch 100 (see FIG. 2) as the value of the quota setting. The set value of 100 GB of switch 100 is set in each of the file servers A and B.

The soft limit of the virtual file system is 100 GB, and the hard limit is (soft limit)×(number of virtual file systems)=100 GB×2=200 GB.

As shown in FIG. 6A, the result of a first inquiry of amounts of use of storage resources of file systems A and B is that 20 GB has been used in both of file systems A and B.

As shown in FIG. 6B, the result of a second inquiry of amounts of use of storage resources of file systems A and B is that 80 GB and 20 GB have been used in file systems A and B, respectively. In this case, the total value of 100 GB of amount of use of storage resources of file systems A and B is equal to the value of the quota setting. Consequently, a transition is made to the grace-period state (namely the grace period).

As shown in FIG. 6C, the value of the quota setting is changed to 80 GB for file system A and to 20 GB for file system B after the expiration of the preset grace period so as to completely prevent the writing of data. In FIG. 6C, the amount 30 GB of storage used in file system B is the amount of data that was written before the value of the quota setting was made 20 GB.

It should be noted that the control illustrated in FIGS. 6A to 6B is not limited to a NAS switch and naturally is applicable to any intermediate unit inserted logically between a terminal and a server.

FIGS. 7A to 7C are diagrams for describing another example of quota control according to the embodiment of the invention shown in FIG. 2. Here the setting of quota for each file system is performed in accordance with the following equation:
value of quota setting of each file system=(value of quota setting: soft limit)−(total value of amounts of use of storage of other file systems constituting the virtual file system)+α
where α is a slack which is an amount that is several percent of the overall amount)

If the quota upper-limit value of each file system is reached in the grace period, the termination of the grace-period state is set using a quota-error response as a key.

In the example shown in FIGS. 7A to 7C, 100 GB is set in the switch 100 as the value of the quota setting. The set value of 100 GB of switch 100 is set in each of the file servers A and B. The soft limit of the virtual file system is 100 GB.

On the other hand, the hard limit is made variable and the following is assumed to hold:
(soft limit)<(hard limit)<(soft limit)×(number of virtual file systems)

In this example, the hard limit is greater than 100 GB and less than 100 GB×2=200 GB.

As shown in FIG. 7A, the values of the quota settings for file systems A and B are made 80 GB+α (where a represents slack) and 40 GB+α (where α represents slack), respectively.

As shown in FIG. 7A, the result of a first inquiry of amounts of use of storage resources of file systems A and B is that 60 GB and 20 GB have been used in file systems A and B, respectively.

If the total value of amount of use of storage resources of file systems A and B has reached the quota setting (exclusive of the slack) after the second survey, a transition is made to the grace-period state, as shown in FIG. 7B.

As shown in FIG. 7C, the values of the quota settings of all file systems are changed after the expiration of the grace period. The value of the quota setting of file system B is changed from 40 GB+α (slack) to 40 GB, which is obtained by eliminating the slack, and the value of the quota setting of file system A is changed from 80 GB+α (slack) to 60 GB.

An access-lock period will be described next. In a case where amount of use of storage resources has fallen below the value of the quota setting following the end of the grace period, there is a period of time that passes until the next survey of amount of use of storage resources is performed. This period of time is referred to as an “access-lock period”. After the value of the quota setting of each file system becomes identical with the amount of use of storage resources in each file system following expiration of the grace period in the access-lock period, writing cannot necessarily be performed even if the amount of use of storage resource is made less than the value of the quota setting by deleting a file. After the amount of use of storage resource becomes an amount less than the value of the quota setting, writing cannot necessarily be carried out until the next survey of amount of use of storage resources ends. The access-lock period is longer than zero and is shorter than the interval of the inquiry of amount of use of storage resources.

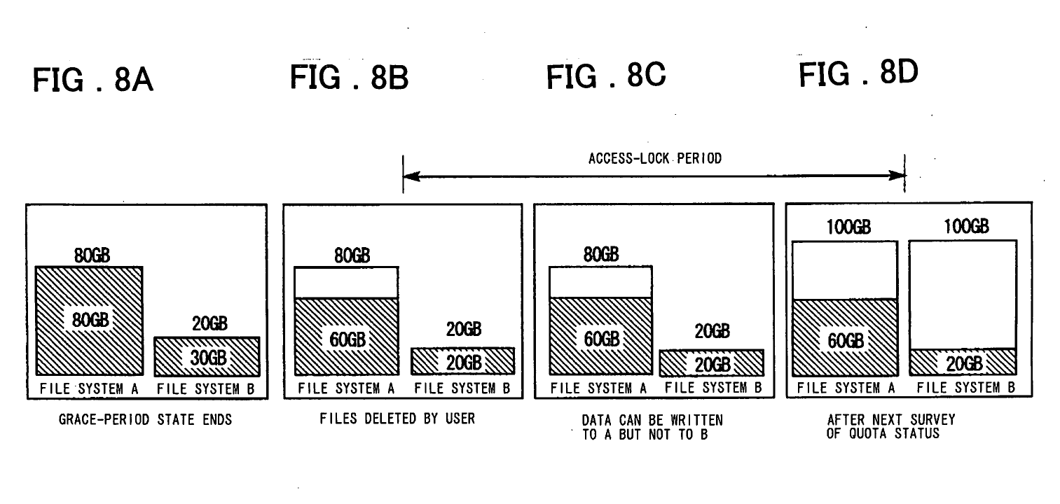

FIG. 8A illustrates the state that prevails at the end of the grace period, in which the amounts of use of storage resources of file systems A and B in FIG. 6C are 80 GB and 30 GB, respectively. After this state is attained, the user deletes files so that the amounts of use of storage resources of file systems A and B become 60 GB and 20 GB, respectively, as illustrated in FIG. 8B. As illustrated in FIG. 8C, data can be written to file system A where the amount of use of storage is less than the quota setting value of 80 GB, but data cannot be written to file system B where the amount of use of storage is identical with the quota setting value of 20 GB. The period of time from FIG. 8B until the next survey of amount of use of storage resources in FIG. 8D is referred to as the “access-lock period”.

With the control shown in FIGS. 6A to 6C, a hard limit (y) is given by the following equation:
y=FS×Quota
where Quota is the soft limit (the value of the quota setting) and
FS is the number of file systems that constitute the virtual file system.

With the control shown in FIGS. 7A to 7C, the hard limit (y) is given by the following equation:
y=FS×Quota−(FS−1)×X
where Quota is the soft limit (the value of the quota setting),
FS is the number of file systems that constitute the virtual file system, and
X is the amount of storage used.

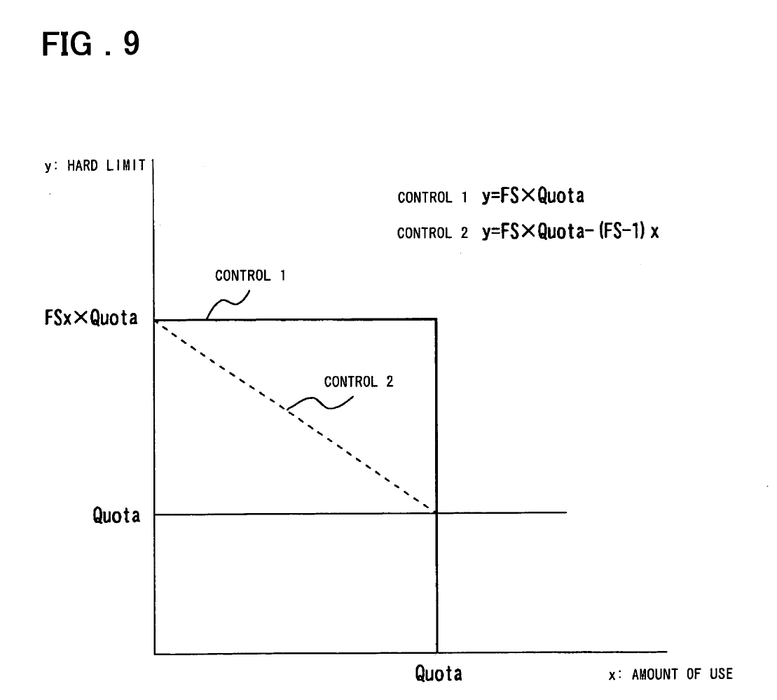

In other words, the hard limit (y) is varied in dependence upon the amount of storage used. FIG. 9 is a graph illustrating y according to the control of FIG. 6 and the control of FIG. 7. The amount X of storage used is assumed to be less than Quota.

Another embodiment of the present invention will now be described. This embodiment is such that on-line migration is made in cooperation in with quota management the switch. According to the present embodiment, the value set in the NAS switch is adopted as the soft limit of the virtual file system, and the hard limit is fixed at the soft limit.

If a value that is a prescribed percentage (70 to 90%) or greater of the quota setting value of each file system is attained, on-line migration is executed so as to render the amount constant. The amount that undergoes on-line migration is decided in such a manner that the amount of storage used in the file system that is the source of the migration will become the amount of storage used in the file system that is the destination of the migration. Although on-line migration is performed frequently, the hard limit can be maintained at the soft limit (the value of the quota setting). In the present embodiment, the unit of quota management is assumed to be solely the directory. The object to undergo migration is determining autonomously. Directories shifted at the time of on-line migration undergo the shift in order starting from the directory of the lowermost layer. Alternatively, the shift is performed in an order that is outside a specific area. In another option, directory candidates shifted may be decided by an algorithm such as LRU (Least Recently Used).

In the present embodiment, migration is not performed if the amount of storage resources used has exceeded the quota setting value (exclusive of slack) of each file system or has exceeded the setting value by more than the amount of the slack.

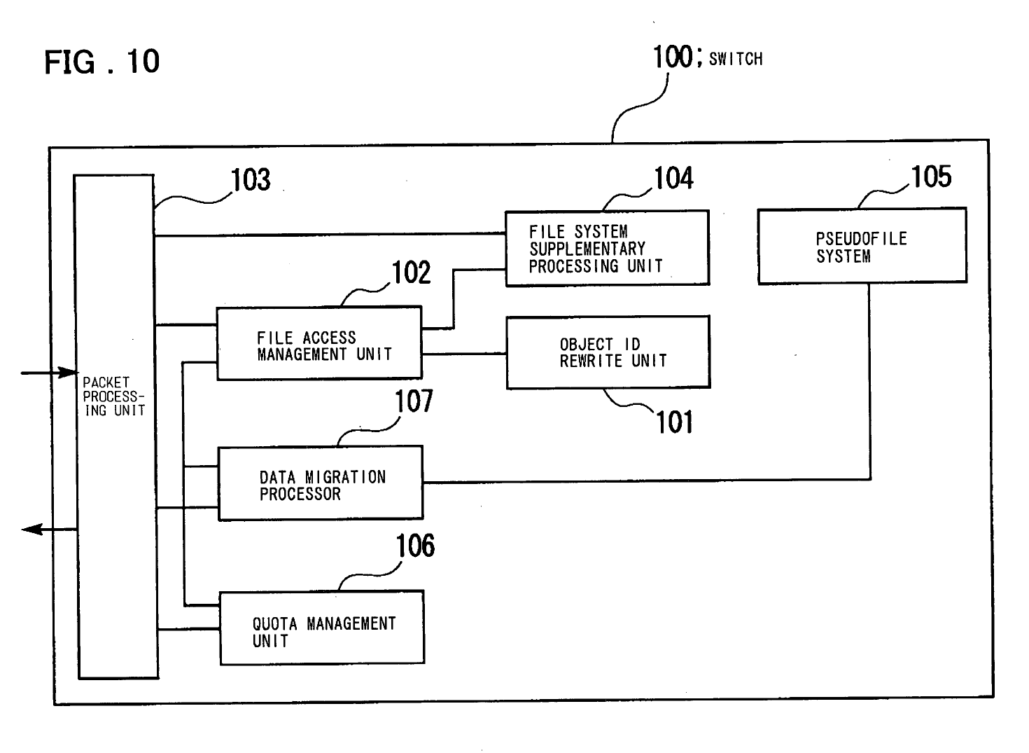

FIG. 10 is a block diagram illustrating the structure of the switch 100 of the present embodiment in which on-line migration and quota management are linked. As shown in FIG. 10, the switch 100 includes the object ID rewrite unit 101, the file access management unit 102, the packet processing unit 103, the file system supplementary processing unit 104, the pseudo file system 105 and the quota management unit 106 provided in switch 100 of FIG. 2, as well as a data migration processor 107.

Based upon the amount of storage used in each server 3 and the value of the quota setting, the data migration processor 107 causes the migration of data among the plurality of servers 3 without changing the directory structure of the consolidated directory tree in the pseudo file system 105.

While maintaining the tree structure of the consolidated directory tree that has been constructed in the pseudo file system 105, the switch 100 causes data to migrate upon copying the tree structure, the basis of which is the laid open directory of each server 3 constituting the consolidated directory tree, to another server A, after which the switch 100 changes the mapping of the tree structure to thereby conceal the migration of the data from the client 1 and diminish capacity inadequacy in the storage unit 5 of the servers 5 while holding the structure of the consolidated directory tree unchanged (for the details, see Patent Document 1).

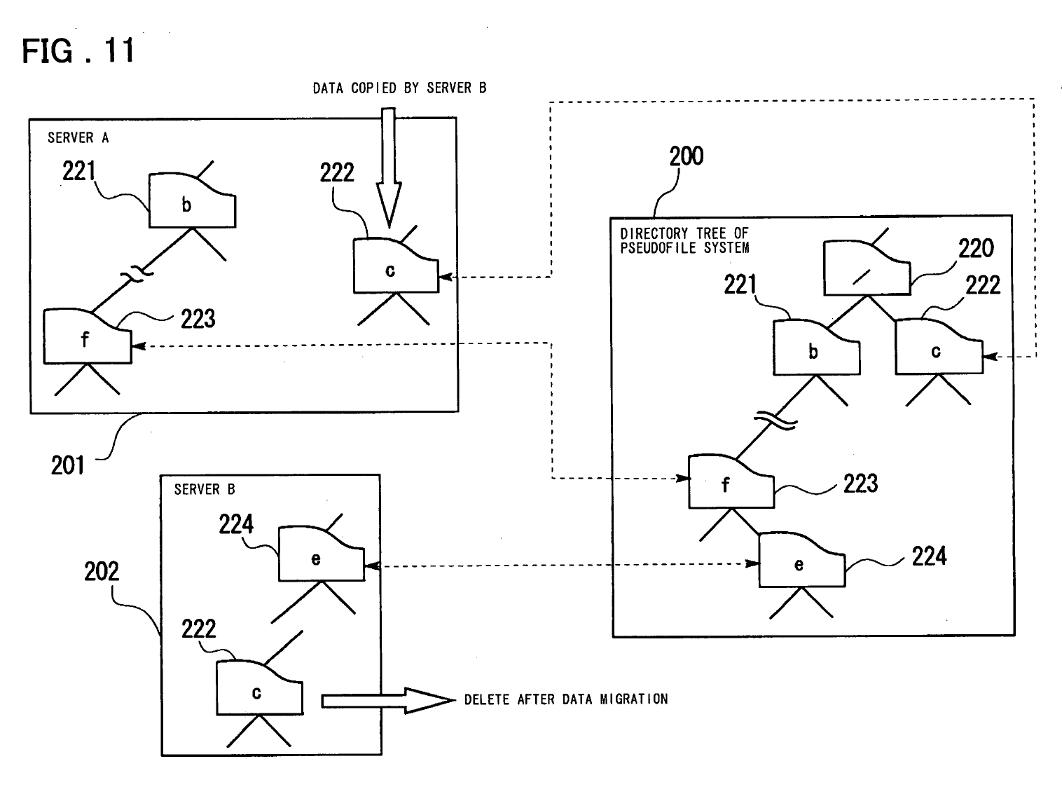

By way of example, in the pseudo file system 105 illustrated in FIG. 4, assume that the remaining storage capacity of the storage unit in server B (202) is small, that the storage unit of server A (201) has residual capacity, and that it is desired that the data in the directory tree from directory c (222) of server B (202) and the attribute information such as the owner of the object and the access privilege be copied to server A (201) together with the tree structure. As shown in FIG. 11, after the switch 100 updates the information of the pseudo file system 105 in such a manner that the directory tree from directory c (222) is re-mapped without changing the structure of the directory tree 200 of pseudo file system 105, the switch 100 deletes the data of the directory tree from directory c (222) of server B (202). Since the remaining storage capacity can be increased while the migration of data is concealed from the client 1, it becomes possible to add on data in the directory tree from directory c (222) or in the directory tree from directory e (224).

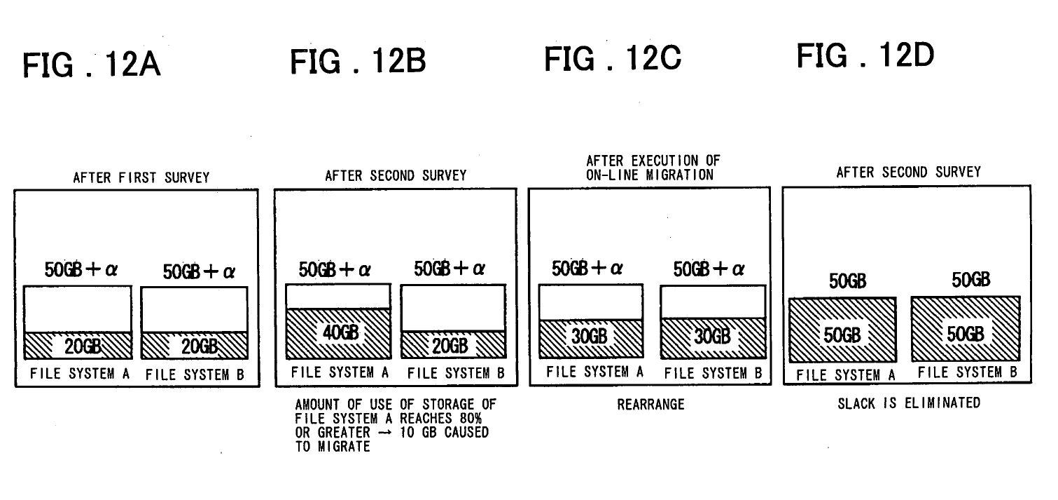

FIGS. 12A to 12D are diagrams for describing quota control that links on-line migration and quota management according to the present embodiment. The values of the quota settings of file systems A and B are assumed to be fixed values.

As shown in FIG. 12A, the value of the quota setting for each of file systems A and B is made 50 GB, which is half of the set value of 100 GB (the soft limit) in switch 100, plus α (namely slack). As a result of the first survey of amount of storage resources used, the amounts of storage used in file systems A and B are 20 GB and 20 GB, respectively.

As a result of the second survey of amount of storage resources used, the amounts of storage used in file systems A and B are 40 GB and 20 GB, respectively, as shown in FIG. 12B. Since the amount of storage used in file system A at this time is 80% of 50 GB, which is the value of the quota setting, 10 GB is caused to migrate from file system A to file system B.

After on-line migration is executed, the amounts of storage used in file systems A and B become 30 GB and 30 GB, respectively, as illustrated in FIG. 12C.

After on-line migration is executed, a second survey is conducted. If, after the second survey, the amount of storage used has attained the value of the quota setting, then the slack α is eliminated and the amounts of storage become 50 GB and 50 GB, as illustrated in FIG. 12D. In this case, the amount of storage used in each of file systems A and B is made the set value and writing of data to the file systems is prohibited as a result.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A file access service system comprising:
at least one terminal;
a plurality of file service providing units each having a function for limiting amount of use of a respective storage resource; and
an intermediate unit inserted between said terminal and the plurality of said file service providing units;
wherein said intermediate unit includes means which, on the basis of a set value of amount of use of a storage resource which has been set in said intermediate unit, is for setting a set value that limits amount of use of each storage resource in a respective one of said file service providing units.

2. The file access service system according to claim 1, wherein said intermediate unit surveys amount of use of each storage resource periodically in each of the said file service providing units and, based upon the result of survey, controls the set value of the amount of use of the storage resource in at least one of said file service providing units.

3. A file access service system comprising:
at least one terminal;
a plurality of file systems; and
an intermediate unit, inserted logically between said terminal and the plurality of said file systems,
said intermediate unit including:
means for providing a file access service in which said file systems are accessed as a virtual file system constituting a single file system as seen by said terminal; and
control means for managing amount of use of storage resources of said virtual file system.

4. The file access service system according to claim 3, wherein said control means further includes means for setting a set value with respect to each of said file systems that construct said virtual file system, wherein the set value limits amount of use of each storage resource of each of said file systems.

5. The file access service system according to claim 3, wherein said control means exercises control to change at least one set value that limits amount of use of each storage resource of each of said file systems in accordance with amount of use of the storage resource in each of said file systems and the set value that limits amount of use of storage resources of said virtual file system.

6. The file access service system according to claim 3, wherein if the amount of use of a storage resource exceeds a prescribed percentage of the set value in at least one file system among said file systems that construct said virtual file system, said control means exercises control to cause the data of said one file system to migrate to another file system.

7. The file access service system according to claim 3, wherein said control means includes means for performing a periodic survey for acquiring amount of use of each storage resource in each of said file systems, and exercising control in such a manner that at least one of said file systems is caused to shift to a grace period of a predetermined length if a total value of amounts of use of storage resources in said file systems acquired by the survey exceeds a set value relating to amount of use of storage resources of said virtual file system.

8. The file access service system according to claim 4, wherein the set value that limits amount of use of each storage resource of each of said file systems that construct said virtual file system is set to a value that satisfies a condition that a total value obtained by adding up each of the set values is equal to a set value that limits amount of use of the storage resources of said virtual file system, or to a value obtained by adding a prescribed amount of slack to the value that satisfies said condition.

9. The file access service system according to claim 7, wherein at least one of said file systems prohibits writing of data from said file system to said terminal after the grace period expires.

10. The file access service system according to claim 7, wherein after the grace period expires, said control means re-sets the set value that limits amount of use of at least one storage resource of said file systems.

11. The file access service system according to claim 3, wherein said intermediate unit comprises a switch apparatus inserted logically between said terminal, which constitutes a client, and servers constructing respective ones of said file systems; and
said switch apparatus receives a file-access request from the client, assigns and transfers the file-access request to a suitable server, receives a response to the file-access requests transmitted from said server, and transfers the response to the client that transmitted the file-access request.

12. The file access service system according to claim 11, wherein said switch apparatus has means for transferring an object-related request, which has been transmitted from the client, to the server that manages the object;
transferring a response to the request from said server to the client that was the source of transmission of the request;
if a source object ID that has been generated by said server is included in the transferred response in order to identify the object, inserting server identification information whereby a server that manages the object corresponding to the source object ID is identified by another server, and rewriting the source object ID to an object ID attended by the information; and
if the object ID attended by the information is included in the transferred request, restoring the object ID attended by the information to the source object ID.

13. The file access service system according to claim 11, wherein said switch apparatus comprises a pseudo file system for managing directory trees of said file systems as a single consolidated directory tree obtained by combining the directory trees, and stores and manages information concerning a first junction of directory trees in the consolidated directory tree.

14. The file access service system according to claim 11, wherein said servers are NAS (Network Attached Storage) devices, and said switch apparatus performs allocation of said servers utilizing prescribed layer information.

15. A switch apparatus connected for communication to at least one client and to a plurality of servers each having means for limiting amount of use of a storage resource of a respective file system; said switch apparatus receiving a file-access request from the client, assigning and transferring the file-access request to a suitable server utilizing prescribed layer information, receiving a response to the file-access request transmitted from the server, and transferring the response to the client that was the source of the file-access request;
said switch apparatus including:
a pseudo file system for managing directory trees of said file systems as a single consolidated directory tree obtained by combining the directory trees, and provides a file access service in which the file systems of said servers are accessed as a virtual file system constituting a single file system as seen by the client; and
control means for managing amount of use of storage resources of said virtual file system.

16. The switch apparatus according to claim 15, wherein said control means
monitors amount of use of storage resources in said file systems with regard to at least one unit of management from among user, group and directory units of management with respect to said file systems that construct said virtual file system; and
in response to a file-access request to said virtual file system from the client, and based upon result of monitoring and a set value that limits amount of use of a storage resource that has been set in relation to said virtual file system, exercises control of a set value that limits amount of use of a storage resource in each of said file systems that construct said virtual file system.

17. The switch apparatus according to claim 15, wherein said control means acquires amount of use of the plurality of storage resources by performing a periodic survey of amount of use of storage resources in each of said file systems to exercise control in such a manner that at least one of said file systems is caused to shift to a grace period of a predetermined length if a total value of amounts of use of storage resources of said file systems exceeds a set value that limits amount of use of storage resources of said virtual file system.

18. A quota management method in a network file system having at least one terminal, a plurality of file systems each having a function for limiting amount of use of a respective storage resource, and an intermediate unit inserted between the terminal and the plurality of file systems, said method comprising the steps of:
said intermediate unit acquiring amount of use of each storage resource in a respective one of said plurality of file systems; and
said intermediate unit setting a set value that limits amount of use of each storage resource in a respective one of the file service providing units based upon a set value of amount of use of a storage resource that has been set in the intermediate unit.

19. The method according to claim 18, wherein said intermediate unit provides a file access service in which said file systems are accessed as a virtual file system constituting a single file system as seen by said terminal, and
wherein said method further comprises steps of:
said intermediate unit managing a set value that limits amount of use of storage resources of the aggregate of said file systems that construct said virtual file system; and
said control means changing at least one of the set values that limit amounts of use of storage resources that have been set in respective ones of said file systems if a total value of amounts of use of storage resources of respective ones of said file systems that construct said virtual file system exceeds the set value that limits amount of use of storage resources of said virtual file system.

20. A computer program product run on a computer constituting a switch apparatus connected for communication to at least one client and to a plurality of servers each having means for limiting amount of use of a storage resource of a respective file system;
said switch apparatus receiving a file-access request from the client, assigning and transferring the file-access request to a suitable server utilizing prescribed layer information, receiving a response to the file-access request transmitted from the server, and transferring the response to the client that was the source of the file-access request;
wherein said switch apparatus includes a pseudo file system for managing directory trees of said file systems as a single consolidated directory tree obtained by combining the directory trees, and provides a file access service in which the file systems of said servers are accessed freely as a virtual file system constituting a single file system as seen by the client;
wherein said program causes the computer to execute the processes of:
setting a set value with respect to each of said file systems that construct said virtual file system, wherein the set value limits amount of use of each storage resource of each of said file system; and
controlling to vary at least one set value that limits amount of use of each storage resource of each of said file systems in accordance with amount of use of the storage resource in each of said file systems and the set value that limits amount of use of storage resources of said virtual file system.
